(19) United States
(12) Patent Application Publication
(10) Pub. No.: US 2007/0126892 A1
(43) Pub. Date: Jun. 7, 2007

(54) Correcting an image captured through a lens

(76) Inventor: Haike Guan, Kanagawa (JP)

Correspondence Address: DICKSTEIN SHAPIRO LLP, 1825 EYE STREET NW, Washington, DC, 20006-5403, US

(21) Appl. No.: 11/606,116

(22) Filed: Nov. 30, 2006

(30) Foreign Application Priority Data
Nov. 30, 2005 (JP) 2005-347372

(51) Int. Cl. H04N 5/225; H04N 5/262

(52) U.S. Cl. 348/240.99; 348/207.99

(57) ABSTRACT

An apparatus, method, system, computer program and product, each capable of correcting aberration or light intensity reduction of an image captured through a lens. A plurality of image correction data items is prepared for a plurality of shooting condition data sets. The image captured under a shooting condition is corrected using one of the plurality of image correction data items that corresponds to the shooting condition.

### CROSS-REFERENCE TO RELATED APPLICATIONS

This patent application is based on and claims priority to Japanese patent application No. 2005-347372 filed on Nov. 30, 2005, in the Japanese Patent Office, the entire contents of which are hereby incorporated by reference.

1. Field

The following disclosure relates generally to an apparatus, method, system, computer program and product, each capable of correcting an image captured through a lens, and more specifically to an apparatus, method, system, computer program and product, each capable of correcting aberration or light intensity reduction of an image caused by a lens.

2. Description of the Related Art

Recently, a digital camera is widely used, which electronically captures an image of an object through a lens. At the same time, there is an increasing demand for a digital camera with high image quality. One of the factors that contribute to poor image quality is aberration of the lens, such as geometric distortion or chromatic aberration. Especially when the image is captured at wide-angle, aberration tends to be highly noticeable.

For example, an image of an object, which is formed on an image plane of the digital camera, may look like the one shown in FIG. 1A without distortion. However, the image may be distorted as illustrated in FIG. 1B or 1C. If magnification of an image forming point increases as a distance of the image forming point from the optical axis passing through the center “O” of the image increases, the image may look like the one having pincushion distortion illustrated in FIG. 1B. If magnification of an image forming point decreases as a distance of the image forming point from the optical axis passing through the center “O” of the image increases, the image may look like the one having barrel distortion illustrated in FIG. 1C.

In order to solve the above-described problem caused by distortion, a plurality of lens elements may be arranged in a manner that will compensate the adverse effect of distortion. However, this increases the overall cost of the digital camera. Another approach is to correct distortion of the image using a distortion correction model, for example, as described in any one of the Japanese Patent Application Publication Nos. 2000-324339, H09-259264, H09-294225, and H06-292207. However, in order to improve correction accuracy, the distortion correction model may need to consider various kinds of parameters. For example, since the image is captured under various shooting conditions, it is preferable to consider a shooting condition under which the image is captured, such as a zoom position of the lens or a shooting distance between the object and the lens center. However, inputting a large number of parameters may slow down the overall processing speed of the digital camera, thus increasing a time for correcting the image. With the increased time for correcting, a user may be prohibited from using the digital camera for a longer time. Further, the digital camera may need to have a large memory space to store a large amount of parameters.

In addition to the problem of having aberration, the lens, especially the wide-angle lens, tends to suffer from the unequal distribution of a light intensity. For example, referring back to any one of FIGS. 1A to 1C, the light intensity level of an image forming point may decrease as a distance of the image forming point from the optical axis passing through the center O of the image increases.

One approach for suppressing the negative effect of the unequal distribution of the light intensity is to correct light intensity reduction or brightness reduction of the image using an intensity correction model, for example, as described in the Japanese Patent Publication No. H11-150681. However, in order to improve correction accuracy, it is preferable to input various kinds of parameters, including a shooting condition under which the image is captured, such as an aperture size of the lens. However inputting a large number of parameters may slow down the overall processing speed of the digital camera, thus increasing a time for correcting the image. Further, the digital camera may need to have a large memory space to store a large amount of parameters.

### SUMMARY

Example embodiments of the present invention provide an apparatus, method, system, computer program and product, each capable of correcting aberration or light intensity reduction of an image captured through a lens.

For example, an image correcting method may be provided, which includes: preparing a plurality of image correction data items in a corresponding manner with a plurality of shooting condition data sets; inputting image data of an object generated from an optical image of the object captured through a lens; inputting a captured shooting condition data set describing a shooting condition under which the optical image is captured; selecting one of the plurality of image correction data items that corresponds to the captured shooting condition data set; and correcting the image data using the selected image correction data item to generate processed image data.

In one example, the image correcting method may be used to correct aberration, such as distortion or chromatic aberration, of the image data. In such case, the captured shooting condition data set includes a zoom position of the lens and an object distance between the lens center and the object. Further, the plurality of image correction data items corresponds to a plurality of distortion correction data items, each data item indicating expected image data that is expected to be captured under a specific shooting condition. In one example, the plurality of distortion correction data items may correspond to a discrete number of samples of a distortion amount and an image height ratio, which are obtained for a plurality of shooting condition data sets. In another example, the plurality of distortion correction data items may correspond to a plurality of coefficients, such as a plurality of polynomial coefficients, which may be derived from the obtained samples. The distortion or chromatic aberration of the image data may be corrected, using one of the plurality of distortion correction data items that corresponds to the captured shooting condition data set.

In another example, the image correcting method may be used to correct light intensity reduction, or brightness reduction, of the image data. In such case, the captured shooting condition data set includes a zoom position of the lens, an object distance between the lens center and the object, and an aperture size of the lens. Further, the plurality of image correction data items corresponds to a plurality of intensity correction data items, each data item indicating expected image data that is expected to be captured under a specific shooting condition. In one example, the plurality of intensity correction data items may correspond to a discrete number of samples of an intensity reduction amount and an image height ratio, which are obtained for a plurality of shooting condition data sets. In another example, the plurality of intensity correction data items may correspond to a plurality of coefficients, such as a plurality of polynomial coefficients, which may be derived from the obtained samples. The intensity reduction or brightness reduction of the image data may be corrected, using one of the plurality of intensity correction data items that corresponds to the captured shooting condition data set.

In another example, the image data may be corrected for a selected portion of the image data. For example, a border section located near the borders of the image data may be selected.

In another example, when correcting the image data, an amount of image correction may be computed for a selected portion of the image data. For example, when the image data is symmetric at the center, the amount of image correction may be computed for the selected one of the portions that are symmetric. One or more portions other than the selected portion may be corrected using the amount of image correction obtained for the selected portion of the image data.

In another example, before correcting the image data, the number of pixels in the image data may be reduced. For example, the image data may be classified into a luma component and a chroma component. The number of pixels in the chroma component may be reduced, for example by applying downsampling.

In another example, an imaging apparatus may be provided, which includes a lens system, an image sensor, a correction data storage, a controller, and an image processor. The lens system captures an optical image of an object through a lens. The image sensor converts the optical image to image data. The correction data storage stores a plurality of distortion correction data items in a corresponding manner with a plurality of shooting condition data sets. The controller obtains a captured shooting condition data set describing the shooting condition under which the optical image is captured by the lens system, and selects one of the plurality of distortion correction data items that corresponds to the shooting condition data set. The captured shooting condition data set includes a zoom position of the lens and a shooting distance between the object and the lens center. The image processor corrects aberration, such as distortion or chromatic aberration, of the image data using the selected distortion correction data to generate processed image data.

In another example, an imaging apparatus may be provided, which includes a lens system, an image sensor, a correction data storage, a controller, and an image processor. The lens system captures an optical image of an object through a lens. The image sensor converts the optical image to image data. The correction data storage stores a plurality of intensity correction data items in a corresponding manner with a plurality of shooting condition data sets. The controller obtains a captured shooting condition data set describing the shooting condition under which the optical image is captured by the lens system, and selects one of the plurality of intensity correction data items that corresponds to the shooting condition data set. The captured shooting condition data set includes a zoom position of the lens, a shooting distance between the object and the lens center, and an aperture size of the lens. The image processor corrects intensity reduction or brightness reduction of the image data using the selected intensity correction data to generate processed image data.

In another example, an image correcting system may be provided, which includes an imaging apparatus and an image processing apparatus. The imaging apparatus may store image data of an object together with a captured shooting condition data set. The image processing apparatus may correct the image data, using one of a plurality of image correction data items that corresponds to the captured shooting condition data set to generate processed image data.

In addition to the above-described example embodiments, the present invention may be implemented in various other ways.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is an illustration of an example image of an object without distortion;

FIG. 1B is an illustration of an example image of an object with pincushion distortion;

FIG. 1C is an illustration of an example image of an object with barrel distortion;

FIG. 2 is a flowchart illustrating operation of correcting image data generated from an optical image captured through a lens, according to an example embodiment of the present invention;

FIG. 3 is an illustration for explaining the amount of distortion of image data according to an example embodiment of the present invention;

FIG. 4 is a graph illustrating the relationship between a distortion amount of a pixel and an image height ratio of the pixel according to an example embodiment of the present invention;

FIG. 5 is a graph illustrating the relationship between a distance of a pixel from the image center and a brightness value of the pixel according to an example embodiment of the present invention;

FIG. 6 is a table showing values of intensity reduction obtained for varied image height ratios and varied zoom positions, according to an example embodiment of the present invention;

FIG. 7 is an illustration for explaining operation of preparing a plurality of intensity correction data items, according to an example embodiment of the present invention;

FIG. 8 is a graph illustrating the relationship between an intensity reduction of a pixel and an image height ratio of the pixel according to an example embodiment of the present invention;

FIG. 9 is an illustration for explaining operation of interpolating image data according to an example embodiment of the present invention;

FIG. 10 is an illustration for explaining operation of correcting intensity reduction of image data according to an example embodiment of the present invention;

FIG. 11A is an example image having chromatic aberration;

FIG. 11B is an example image in which chromatic aberration shown in FIG. 11A is corrected;

FIG. 12 is a schematic block diagram illustrating the functional structure of an image correcting system according to an example embodiment of the present invention;

FIG. 13 is a schematic block diagram illustrating the hardware structure of an imaging apparatus according to an example embodiment of the present invention;

FIG. 14 is a flowchart illustrating operation of correcting image data generated from an optical image captured through a lens, performed by the imaging apparatus of FIG. 13, according to an example embodiment of the present invention;

FIG. 15 is a flowchart illustrating operation of storing image data and shooting condition data, performed by the imaging apparatus of FIG. 13, according to an example embodiment of the present invention;

FIG. 16 is a schematic block diagram illustrating the functional structure of an image correcting system according to an example embodiment of the present invention;

FIG. 17 is a schematic block diagram illustrating the hardware structure of an image processing apparatus according to an example embodiment of the present invention; and

FIG. 18 is a flowchart illustrating operation of correcting image data generated from an optical image captured through a lens, performed by the image processing apparatus of FIG. 17, according to an example embodiment of the present invention.

### DETAILED DESCRIPTION OF THE INVENTION

In describing the example embodiments illustrated in the drawings, specific terminology is employed for clarity. However, the disclosure of this patent specification is not intended to be limited to the specific terminology selected and it is to be understood that each specific element includes all technical equivalents that operate in a similar manner. For example, the singular forms “a”, “an” and “the” may include the plural forms as well, unless the context clearly indicates otherwise.

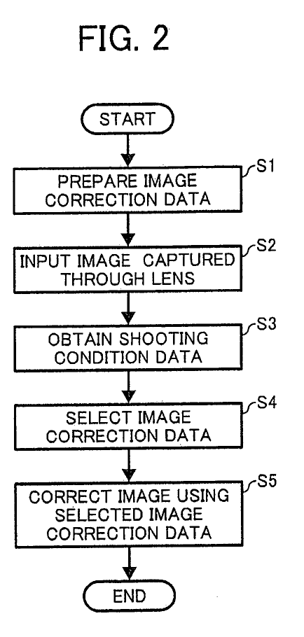

Referring now to the drawings, wherein like reference numerals designate identical or corresponding parts throughout the several views, FIG. 2 illustrates operation of correcting image data generated from an optical image captured through a lens according to an example embodiment of the present invention. As described above, the lens described herein may correspond to a plurality of lens elements that together function as a single lens element.

Step S1 prepares image correction data, which may be used to correct the image data to suppress the negative effect of aberration or light intensity reduction caused by the lens.

In one example, in order to suppress the negative effect of distortion, a plurality of distortion correction data items may be prepared.

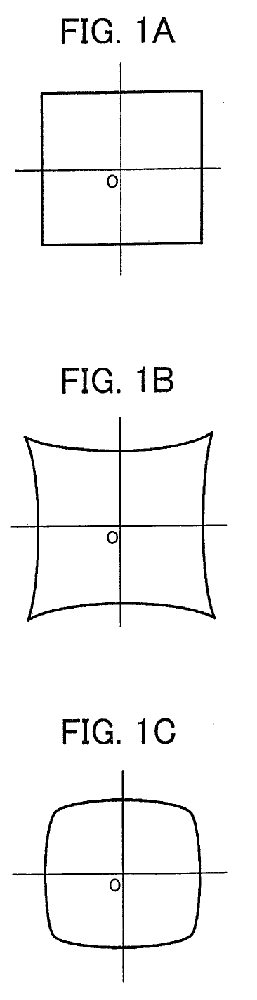

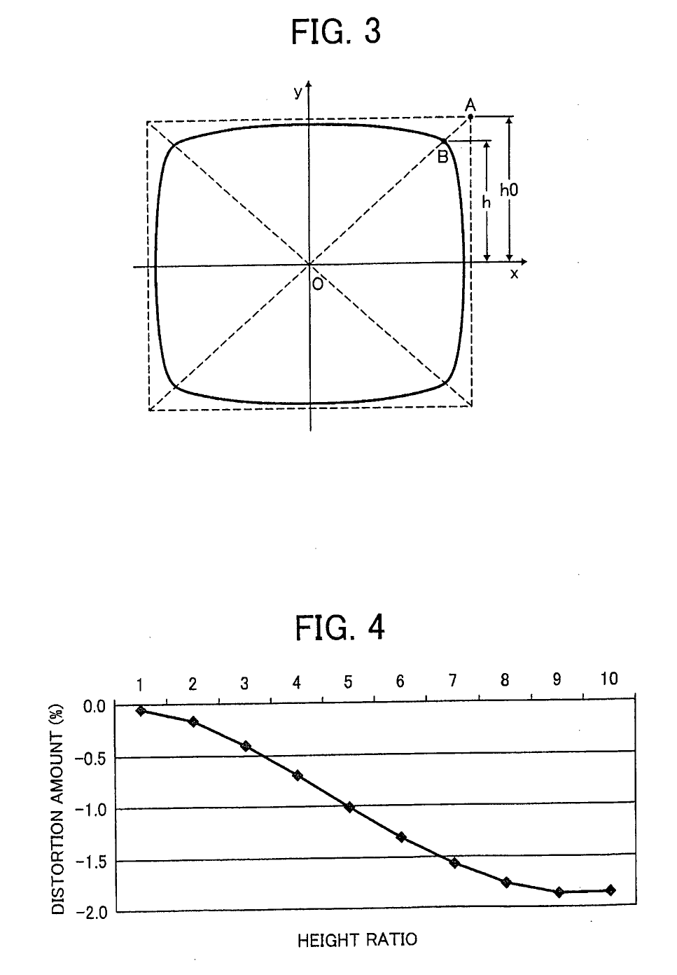

As illustrated in FIG. 1B or 1C, an image of an object may be distorted due to the change in magnification of the image. FIG. 3 illustrates example image data converted from an optical image formed on an image plane. In this example, the optical image is formed with barrel distortion. However, the optical image may be formed with pincushion distortion. The x coordinate value corresponds to a distance of a pixel from the center O in the horizontal direction. The y coordinate value corresponds to a distance of a pixel from the center O in the vertical direction. The center O of the image data, which corresponds to the point passing through the optical axis, functions as the origin of the x-y coordinate system. In addition to location information such as the x and y values, each pixel in the image data of FIG. 3 may contain color information, such as the brightness value.

Still referring to FIG. 3, when the pixel located at the upper right corner is formed on the image plane without distortion, the pixel is formed at the position “A”. When the image is formed on the image plane with distortion, the pixel of the image located at the upper right corner may be formed at the position “B”. The amount of distortion D (“the distortion amount D”), which may expressed in %, may correspond to the difference between the position A and position B, for example, as illustrated in the following equation (referred to as “the first equation”):
D=(h−h0)/h0*100.

In the above-described equation, the expected image height h0 corresponds to a distance between the pixel and the center O when the image is formed without distortion, which may be expressed as the y-coordinate value of the pixel formed without distortion. The input image height h corresponds to a distance between the pixel and the center O when the image is formed with distortion, which may be expressed as the y-coordinate value of the pixel formed with distortion. In this example, the input image height h is expressed as the image height ratio H, which is obtained by normalizing the input image height h by the expected image height h0.

It is known that the distortion amount D depends on various parameters, such as the zoom position, i.e., the focal length, of the lens, and a distance (“object distance”) between the lens center and the object. The zoom position and/or the object distance may change every time the image is captured. Accordingly, the distortion amount D may change every time the image is captured. For this reason, when preparing the distortion correction data, the zoom position and the object distance may need to be considered as shooting condition data, which describes a condition under which the image is captured.

In order to prepare the plurality of distortion correction data items for a plurality of shooting condition data sets, the distortion amount D may be obtained for each one of varied image height ratios H for each one of the plurality of sets of the zoom position and the object distance. The distortion amount D may be obtained, for example, using the ray tracking method with the help of an optical simulation tool. The plurality of distortion correction data items, each of which describes the distortion amounts D for the varied image height ratios H, may be obtained in the form of linear equation as illustrated in FIG. 4. Alternatively, the plurality of distortion correction data items may be obtained in the form of tables, each table storing the distortion amounts D and the varied image height ratios in a corresponding manner for the plurality of sets of the zoom position and the object distance. The plurality of distortion correction data items may be stored for later use.

Further, in order to improve the correction accuracy, the distortion correction data illustrated in FIG. 4 may be converted to a polynomial equation (referred to as “the second equation”):
D=A0+A1*H1+A2*H2+ . . . +An*Hn,
wherein A0 to An correspond to the polynomial coefficients, and H1 to Hn correspond to the varied image height ratios H. The polynomial coefficients A0 to An may be derived from the discrete number of samples of the distortion amounts D and the image height ratios H obtained as described above, for example, using the least-squared polynomial approximation. Using the polynomial coefficients A0 to An, distortion of the image may be corrected with higher accuracy when compared to the example case of using the linear equation. The polynomial coefficients A0 to An may be stored for later use for each one of the plurality of sets of the zoom position and the object distance. Compared to the case of storing the discrete number of sets of the distortion amount D and the image height ratio H for each one of the plurality of sets of the zoom position and the object distance in the form of tables, storing the polynomial coefficients A0 to An requires less memory space.

In another example, in order to suppress the negative effect of unequal distribution of light intensity, a plurality of intensity correction data items may be prepared.

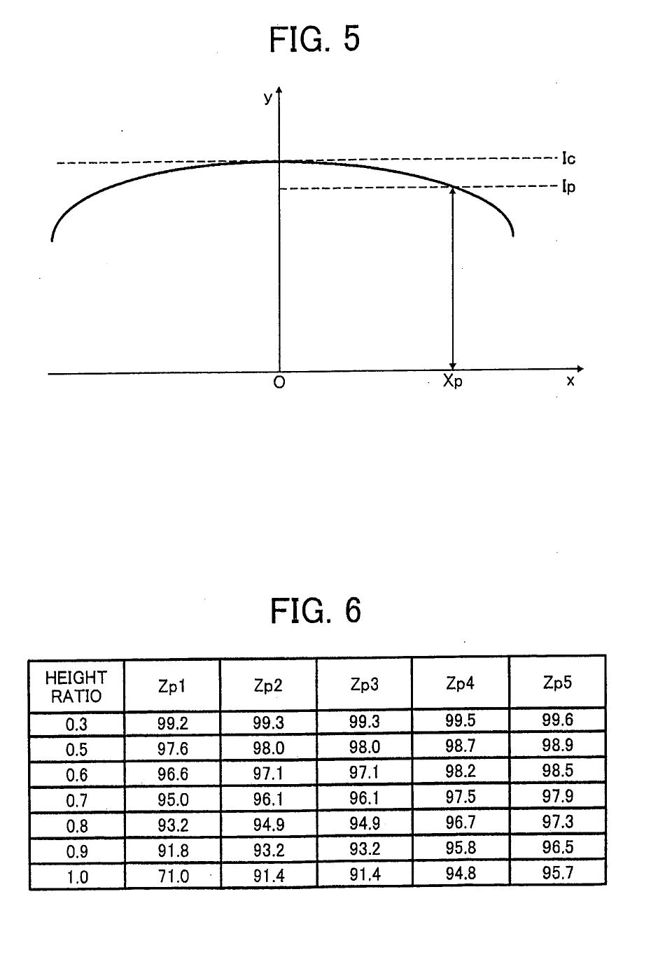

As described above, light intensity of the light passing through the lens may be unequally distributed due to the lens characteristics. Accordingly, the brightness values of the pixels in the image data may be unequally distributed, for example, as illustrated in FIG. 5. In FIG. 5, the x coordinate value corresponds to a distance of a pixel from the center 0 of the image data in the horizontal or vertical direction. The y coordinate value corresponds to the brightness value of the pixel in the image data. The center O of the image data, which corresponds to the point passing through the optical axis, functions as the origin of the x-y coordinate system. The pixel located at the center O has the maximum brightness value Ic. The brightness value of a pixel decreases as a distance of the pixel from the center O of the image data increases. When the pixel is located at the position Xp, the pixel has the brightness value Ip, which is less than the brightness value Ic. The amount of light intensity reduction P (“the intensity reduction P”), which may be expressed in %, may be defined as the ratio between the brightness value Ic and the brightness value Ip, for example, as illustrated in the following equation (referred to as “the third equation”):
P=(Ip/Ic)*100.

In this example, gamma correction may be applied to the brightness value of the pixel.

It is known that the intensity reduction P depends on various parameters, such as the zoom position of the lens, the object distance, and the aperture size of the lens. The aperture size of the lens may be defined, for example, using the f-number of the digital camera. The zoom position, the object distance, and/or the aperture size may change every time the image is captured. Accordingly, the intensity reduction P may change every time the image is captured. For this reason, when preparing the intensity correction data, the zoom position, the object distance, and the aperture size may need to be considered as shooting condition data, which describes a condition under which the image is captured.

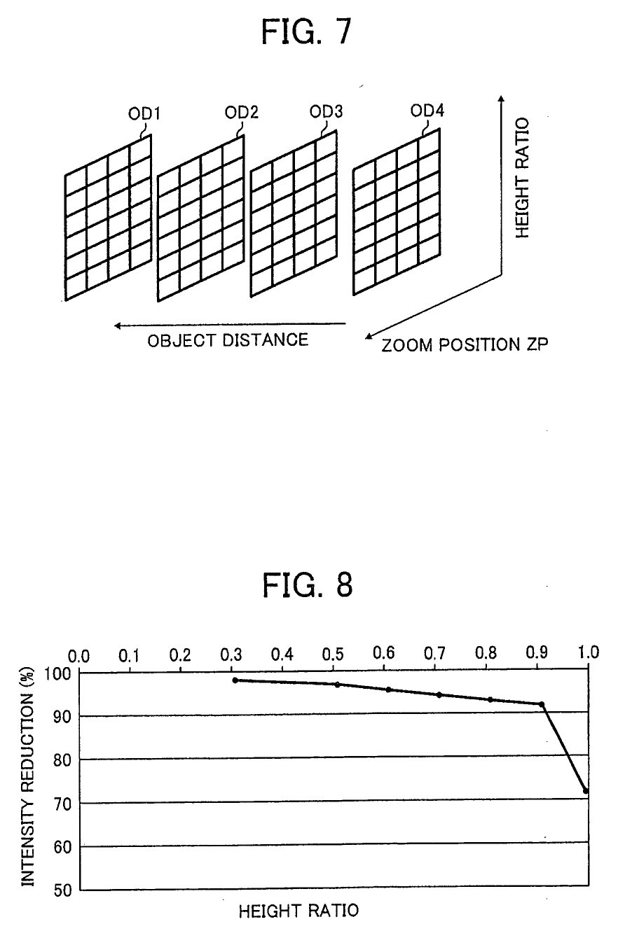

In order to prepare the plurality of intensity correction data items for a plurality of shooting condition data sets, the intensity reduction P may be obtained for each one of varied image height ratios H for each one of the plurality of sets of the zoom position, the object distance, and the aperture size. The intensity reduction P may be obtained, for example, using the ray tracking method with the help of an optical simulation tool. For example, as illustrated in FIGS. 6 and 7, the intensity reduction P is obtained for the varied image height ratios H and the varied zoom positions Zp1 to Zp5 for a first object distance OD1 with a predetermined aperture size. In a substantially similar manner, the intensity reduction P is obtained for the varied image height ratios H and the varied zoom positions Zp1 to Zp5 at each of a plurality of object distances including the object distances OD2, OD3, and OD4, with the predetermined aperture size. Further, the intensity reduction P may be obtained for the varied aperture sizes.

As a result, the plurality of intensity correction data items, each of which describes the intensity reduction P for the varied image height ratios H, may be obtained in the form of linear equation as illustrated in FIG. 8. Alternatively, the plurality of intensity correction data items may be obtained in the form of tables, each table storing the intensity reductions P and the varied image height ratios H in a corresponding manner with the plurality of sets of the zoom position, the object distance, and the aperture size. The plurality of intensity correction data items may be stored for later use.

Further, in order to improve the correction accuracy, the intensity correction data illustrated in FIG. 8 may be converted to a polynomial equation (referred to as “the fourth equation”):
P=B0+B1*H1+B2*H2+ . . . +Bn*Hn,
wherein B0 to Bn corresponds to the polynomial coefficients, and H1 to Hn correspond to the varied image height ratios H. The polynomial coefficients B0 to Bn may be derived from the discrete number of samples of the intensity reductions P and the image height ratios H obtained as described above, for example, using the least-squared polynomial approximation. Using the polynomial coefficients B0 to Bn, intensity reduction of the image may be corrected with higher accuracy when compared to the example case of using the linear equation. The polynomial coefficients B0 to Bn may be stored for later use for each one of the plurality of sets of the zoom position, the object distance, and the aperture size. Compared to the case of storing the discrete number of sets of the intensity reduction P and the image height ratio H for each one of the plurality of sets of the zoom position, the object distance, and the aperture size, storing the polynomial coefficients B0 to Bn requires less memory space.

Referring back to FIG. 2, Step S2 inputs image data generated from an optical image captured through the lens. The image may be captured by any kind of imaging device having the lens, for example, a digital camera. In one example, the image data may be obtained directly from the imaging device. In another example, the image data may be obtained from a storage device or medium.

Step S3 obtains a captured shooting condition data set, which describes a shooting condition under which the image is captured. In one example, the shooting condition data set may include a zoom position of the lens and an object distance between the lens center and the object. In another example, the shooting condition data set may include an aperture size of the lens in addition to the zoom position and the object distance. In another example, the shooting condition data set may include identification information, which identifies the imaging device used for capturing the optical image, in addition to the zoom position and the object distance, or in addition to the zoom position, the object distance, and the aperture size. The captured shooting condition data set may be obtained directly from the imaging device, or it may be obtained from any kind of storage device or medium.

Step S4 select the image correction data item that corresponds to the captured shooting condition data set obtained in Step S3. In one example, the zoom position and the object distance are extracted from the captured shooting condition data set obtained in Step S3. In order to correct distortion of the image obtained in Step S2, the distortion correction data item, which corresponds to the extracted set of the zoom position and the object distance, is selected from the plurality of distortion correction data items. As described above referring to Step S1, the distortion correction data item may be stored, for example, in the form of tables or coefficients.

In another example, the zoom position, the object distance, and the aperture size are extracted from the shooting condition data set obtained in Step S3. In order to correct intensity reduction of the image obtained in Step S2, the intensity correction data item, which corresponds to the extracted set of the zoom position, the object distance, and the aperture size, is selected from the plurality of intensity correction data items. As described above referring to Step S1, the intensity correction data item may be stored, for example, in the form of tables or coefficients.

Step S5 corrects the input image data, using the selected image correction data item selected in Step S4.

In one example, using the polynomial coefficients A0 to An obtained as the distortion correction data item in Step S4, the expected position x0 of the pixel in the horizontal direction is obtained from the input position x of the pixel detected in the image plane using the following equation:
x=x0(1+A0+A1*H1+A2*H2+ . . . +An*Hn).

Similarly, the expected position y0 of the pixel in the vertical direction is obtained from the input position y of the pixel detected in the image plane using the following equation:
y=y0(1+A0+A1*H1+A2*H2+ . . . +An*Hn).

The pixel of the image is moved from the input position (x, y) to the expected position (x0, y0) to correct distortion of the image.

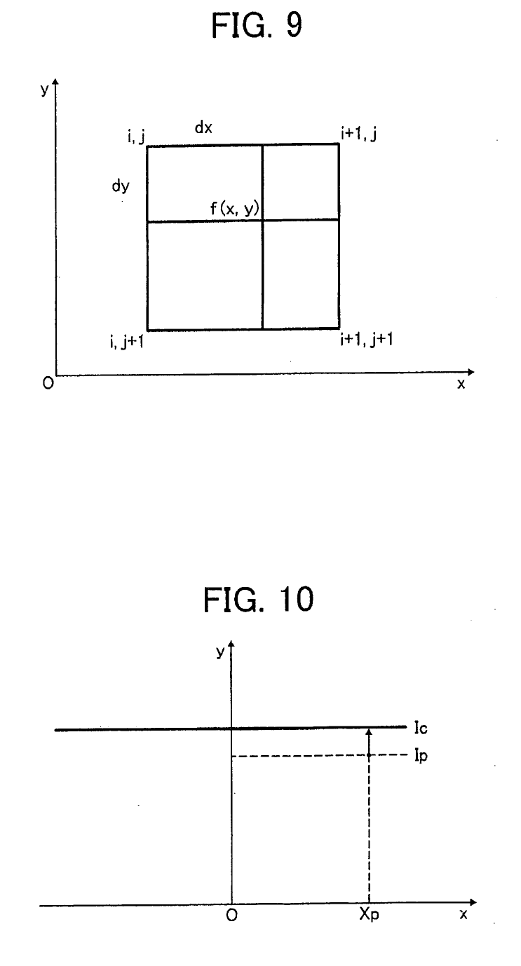

Further, in this example, the value of the pixel, which is now located at the expected position (x0, y0), may be calculated from the values of the neighboring pixels of the pixel when the pixel is located at the input position (x, y). For example, as illustrated in FIG. 9, the value of the pixel may be calculated using the following linear interpolation equation:
f(x, y)=(f(i, j)*(1−dx)+f(i+1,j)*dx)*(1−dy)+f(i,j+1)*(1−dx)+f(i+1, j+1)*dx)dy.

However, any desired interpolation method or any other kind of image processing may be used to improve appearance of the corrected image.

In another example, using the polynomial coefficients B0 to Bn obtained as the intensity correction data item in Step S4, the intensity reduction P may be calculated using the fourth equation by inputting the location information of the pixel. Once the intensity reduction P is obtained, the brightness value Ic of the pixel at the center O of the image may be obtained using the third equation. Referring to FIG. 10, the brightness value Ip of the pixel located at the position Xp is adjusted to be equal to the brightness value Ic. In this manner, light intensity reduction, or brightness reduction, of the image is corrected.

The operation of FIG. 2 may be performed in various other ways.

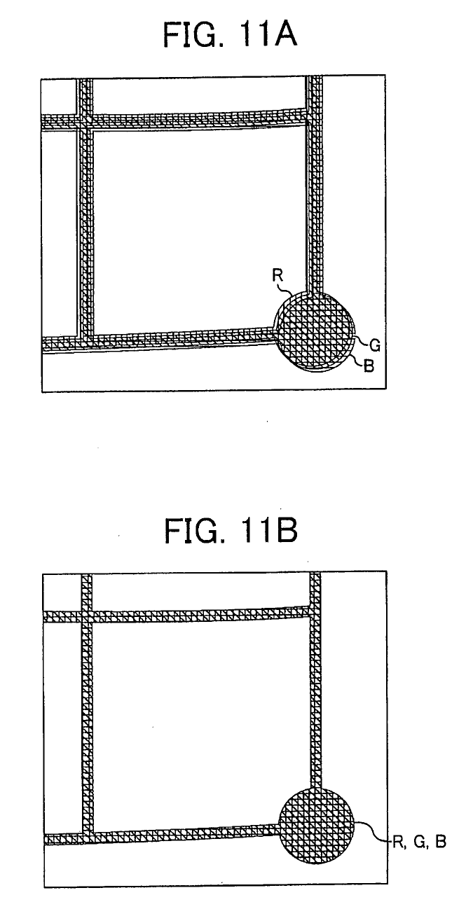

In one example, in Step S5, magnification chromatic aberration of the input image may be corrected using the selected distortion correction data item. For example, the light passing through the lens may be divided into the red component, the green component, and the blue component. Since the image magnification may differ according to the wavelength of the light, the red, green, and blue components may be formed at different locations on the image plane, thus lowering image quality of the image data, as illustrated in FIG. 11A.

The magnification chromatic aberration of each one of the red, green, and blue components may be corrected in a substantially similar manner as described above referring to the example case of correcting distortion of the image.

For example, magnification of the green component of the image data may be corrected using the distortion correction data item in a substantially similar manner as described above referring to the case of correcting distortion of the image data. Once the magnification of the green component of the image data is corrected, the magnification of the red component of the image data may be corrected using the following equation:
Mr=(hr−hg)/hg*100.

In the above-described equation, the expected image height hr corresponds to a distance between the red-color pixel and the center O when the image is formed without aberration, which may be expressed as the y-coordinate value of the red-color pixel without aberration. The expected image height hg corresponds to a distance between the green-color pixel and the center O when the image is formed without aberration, which may be expressed as the y-coordinate value of the green-color pixel without aberration. Since the expected image height hg can be obtained using the distortion correction data item, the excepted image height hr is obtained using the above-described equation.

Similarly, the magnification of the blue component of the image data may be corrected using the following equation:
Mb=(hb−hg)/hg*100.

In the above-described equation, the expected image height hb corresponds to a distance between the blue-color pixel and the center O when the image is formed without aberration, which may be expressed as the y-coordinate of the blue-color pixel without aberration. The expected image height hg corresponds to a distance between the green-color pixel and the center O when the image is formed without aberration, which may be expressed as the y-coordinate of the green-color pixel without aberration. Since the expected image height hg can be obtained using the distortion correction data item, the excepted image height hb is obtained using the above-described equation.

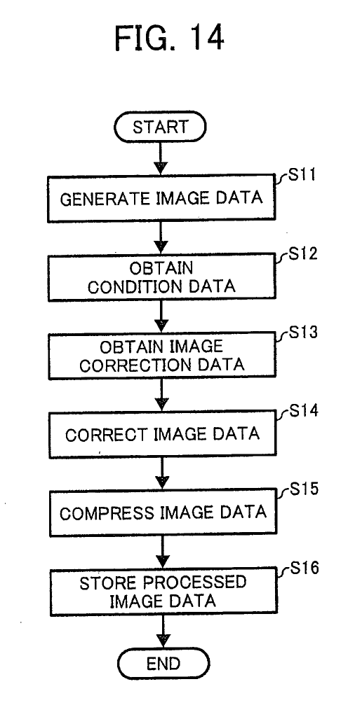

Accordingly, by adjusting the red component and the blue component of the image data based on the green component of the image data after correcting distortion of the green component of the image data, magnification chromatic aberration of the image data may be easily corrected, for example, as illustrated in FIG. 14B.

Referring to FIG. 2, in another example, in Step S5, aberration or intensity reduction may be corrected for a selected portion of the image data.

Referring back to FIG. 1B or 1C, distortion of the image is highly noticeable especially when the pixel is located near the borders of the image. Similarly, referring to FIG. 5, intensity reduction is highly noticeable especially when the pixel is located near the boarders of the image. Using this characteristic, image correction may be applied to a border section of the image data. In this manner, the processing speed may increase. In this example, the border section of the image data may be previously determined based on experimental data. For example, the border section may count for around 30% of the image data.

In another example, the number of pixels in the image data may be reduced before performing Step S5 of correcting. For example, the image data may be classified into a luma component and a chroma component. The number of pixels in the chroma component may be reduced, for example, by applying downsampling.

In another example, in Step S5 of correcting, an amount of image correction may be computed for a selected portion of the image data. For example, when the optical image is captured through the lens that is symmetric, the image data generated from the optical image becomes symmetric at the center O as illustrated in FIG. 3. Using this characteristic, the amount of image correction may be computed for a selected one of the portions that are symmetric. The amount of image correction computed for the selected portion may be used to correct other portions of the image data. Referring to FIG. 3, the amount of image correction may be computed for the pixels located in one of four quadrants. The amount of image correction obtained for the selected quadrant is used to correct the pixels located in the other quadrants of the image data.

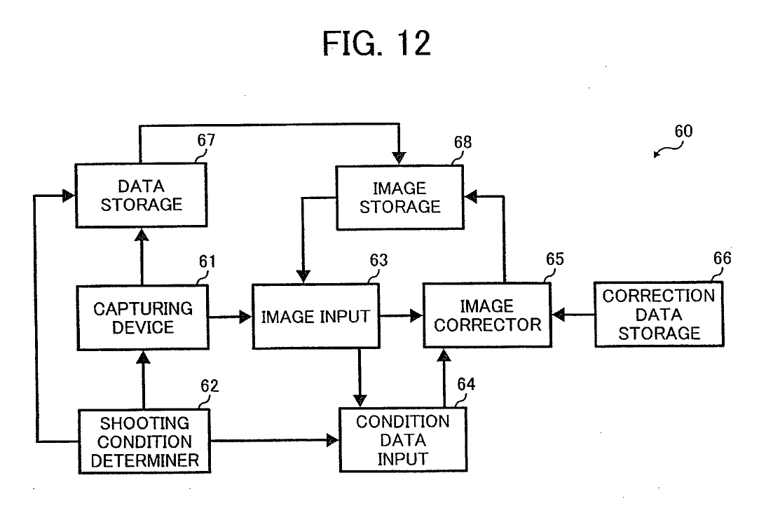

The operation of FIG. 2 may be performed by various devices, apparatuses, or systems, for example, as described below referring to FIGS. 12 to 18.

In one example, the operation of FIG. 2 may be performed by a first image correcting system 60 having the functional structure shown in FIG. 12.

Referring to FIG. 12, the first imaging correcting system 60 includes a capturing device 61, a shooting condition determiner 62, an image input 63, a condition data input 64, an image corrector 65, a correction data storage 66, a data storage 67, and an image storage 68.

The capturing device 61 captures an optical image of an object through a lens, and converts the optical image to image data. The shooting condition determiner 62 determines a shooting condition under which the optical image is captured, such as a zoom position of the lens, an object distance between the lens center and the object, and/or an aperture size of the lens. The image input 63 inputs the image data generated by the capturing device 61, which may be obtained directly from the capturing device 61 or through any other device such as the data storage 67 or the image storage 68. The condition data input 64 obtains a captured shooting condition data set, which describes the shooting condition determined by the shooting condition determiner 62. For example, the zoom position, the object distance, and/or the aperture size may be obtained, which describes the shooting condition under which the optical image is captured. The correction data storage 66 stores a plurality of image correction data items, for example, a plurality of distortion correction data items or a plurality of intensity correction data items, which may be previously prepared in a corresponding manner with a plurality of shooting condition data sets. The image corrector 65 corrects the image data input by the image input 63, using one of the plurality of image correction data items selected from the correction data storage 66. The selected image correction data item corresponds to the captured shooting condition data set input by the condition data input 64. The data storage 67 stores data, such as the image data generated by the capturing device 61 and/or the captured shooting condition data set describing the shooting condition determined by the shooting condition determiner 62.

The image storage 68 stores data, such as the image data obtained from the data storage 67, the captured shooting condition data set obtained from the data storage 67, and/or the processed image data corrected by the image corrector 65.

In one example, the image corrector 65 corrects the image data of the object when the optical image is captured, and stores the processed image data in the image storage 68. This operation of correcting the image data when the optical image is captured may be referred to as real time processing. In another example, the data storage 67 may store the uncorrected image data of the object in the image storage 68 together with the captured shooting condition data set describing the shooting condition determined by the shooting condition determiner 62. This operation of storing the uncorrected image data together with the shooting condition data set may be referred to as non-real time processing. The real time processing or the non-real time processing may be previously set, for example, according to a user instruction.

In the real time processing, the image input 63 inputs the image data obtained from the capturing device 61. The condition data input 64 inputs the captured shooting condition data set, which describes the shooting condition determined by the shooting condition determiner 62. The image corrector 65 selects one of the plurality of image correction data items stored in the correction data storage 66, which corresponds to the captured shooting condition data set. Using the selected image correction data item, the image corrector 65 corrects the image data input by the image input 63, and stores the processed image data in the image storage 68.

When the first image correcting system 60 performs the real time processing, in one example, the capturing device 61, the shooting condition determiner 62, the image input 63, and the condition data input 64, and the image corrector 65 may be preferably incorporated into one apparatus, such as an imaging apparatus. In such case, the image input 63, the condition data input 64, and the image corrector 65 may be provided as a firmware, which may be installed to the imaging apparatus having the capturing device 61 and the shooting condition determiner 62.

In the non-real time processing, the data storage 67 stores, in the image storage 68, the image data generated by the capturing device 61 together with the captured shooting condition data set describing the shooting condition determined by the shooting condition determiner 62. For example, the captured shooting condition data set may be stored as property data of the image data. Since the captured shooting condition data set is stored together with the image data, the image data may be corrected at any time while considering the shooting condition under which the image is captured. When correcting, the image input 63 inputs the image data, which is obtained from the image storage 68. The condition data input 64 inputs the captured shooting condition data set, which is obtained from the image storage 68. The image corrector 65 selects one of the plurality of image correction data items that corresponds to the captured shooting condition data set, from the correction data storage 66. Using the selected image correction data item, the image corrector 65 applies image correction to the image data input by the image input 63, and stores the processed image data in the image storage 68.

When the first image correcting system 60 performs non-real time processing, in one example, the capturing device 61 and the shooting condition determiner 62 may be incorporate into one apparatus, such as an imaging apparatus. The image input 63, the condition data input 64, and the image corrector 65 may be incorporated into one apparatus, such as an image processing apparatus. In another example, the capturing device 61, the shooting condition determiner 62, the image input 63, the condition data input 64, and the image corrector 65 may be incorporated into one apparatus, such as an imaging apparatus.

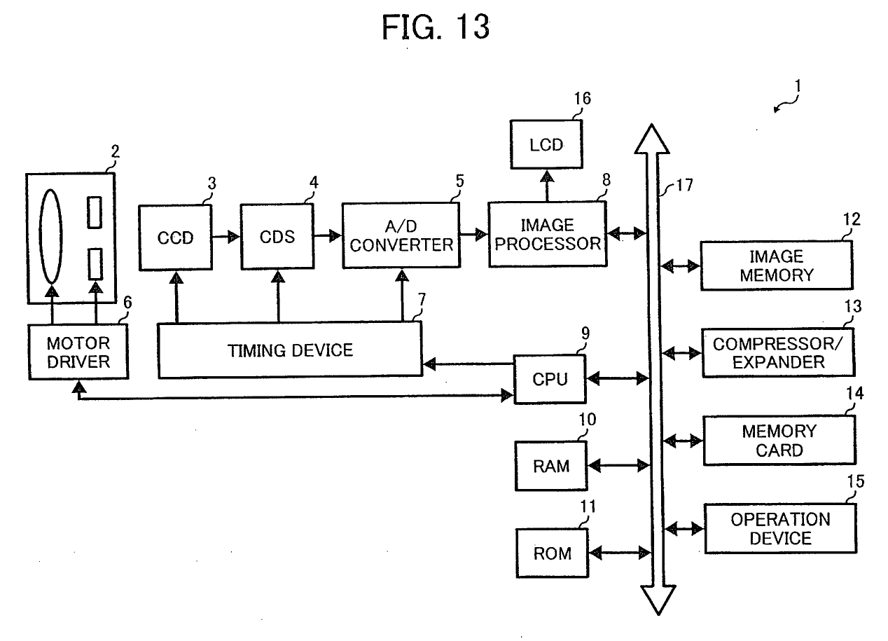

The first image correcting system 60 may be implemented by, for example, a digital camera 1 illustrated in FIG. 13.

Referring to FIG. 13, the digital camera 1 includes a lens system 2, a charged coupled device (CCD) 3, a correlated double sampling device (CDS) 4, an analog/digital converter (A/D) 5, a motor driver 6, a timing device 7, an image processor 8, a central processing unit (CPU) 9, a random access memory (RAM) 10, a read only memory (ROM) 11, an image memory 12, a compressor/expander 13, a memory card 14, an operation device 15, and a liquid crystal display (LCD) 16.

The lens system 2 may include a lens having one or more lens elements, an aperture adjustment device for regulating the amount of light passing through the lens, and a time adjustment device for regulating the time during which the light passes. In this example, the lens system 2 includes a zoom lens with the varied focal length or the varied angle of view. Further, the lens system 2 includes a mechanical shutter, which controls the amount or time of light passing through the lens. The lens system 2 is driven by a motor, such as a pulse motor, which may be driven by the motor driver 6 under control of the CPU 9.

In operation, according to an instruction from the CPU 9, the lens of the lens system 2 is moved along the optical axis toward or away from an object provided in front of the lens system 2. In this manner, the zoom position of the lens, i.e., the focal length of the lens, or the object distance between the object and the lens center, may be determined. In this example, the object distance may be obtained using a pulse signal output from the pulse motor, which may be controlled by the CPU 9. Further, the f-number of the lens, which corresponds to the aperture size of the lens, may be adjusted by the shutter of the lens system 2 under control of the CPU 9.

The CCD 3 converts the optical image, which is formed on the image plane of the CCD 3 by the light passing through the lens system 2, to an electric signal, i.e., analog image data. In this example, any desired image sensor may be incorporated in alternative to the CCD 3, including a complementary metal oxide semiconductor (CMOS) device, for example. The CDS 4 removes a noise component from the analog image data received from the CCD 3. The A/D converter 5 converts the image data from analog to digital, and outputs the digital image data to the image processor 8. At this time, the image data may be stored in the image memory 12. Alternatively, the image data may be stored in the image memory 12 together with the captured shooting condition data set describing the shooting condition under which the optical image is captured. Further, the image data, and/or any portion of the captured shooting condition data set, may be displayed on the LCD 16. The CCD 3, the CDS 4, and the A/D converter 5 are each controlled by the CPU 9 through the timing device 7. In this example, the timing device 7 outputs a timing signal according to an instruction of the CPU 9.

The image processor 8 may apply various image processing to the digital image data. In one example, the image processor 8 may apply color space conversion. For example, the RGB image data may be converted to the YUV image data, such as the YCbCr image data. The image processor 8 may further apply subsampling to the 4:4:4 YCbCr image data to generate the 4:2:2 YCbCr image data. In another example, the image processor 8 may adjust the color of the image, for example, by applying white balance control that adjusts the color temperature of the image. In another example, the image processor 8 may apply contrast control to adjust the contrast of the image. In another example, the image processor 8 may apply edge enhancing to adjust the sharpness of the image. The image data may be stored in the memory card 14, after being processed by the image processor 8. The memory card 14 includes any kind of involatile memory, such as a flash memory. At this time, the image data may be compressed by the compressor/expander 13 using any desired compression method, such as the JPEG or the exchangeable image file format (Exif). Further, the processed image data, and/or any portion of the captured shooting condition data set, may be displayed on the LCD 16. The image processor 8, the compressor/expander 13, and the memory card 14 are each controlled by the CPU 9 through a bus 17.

The CPU 9 includes any kind of processor capable of controlling operation of the digital camera 1. The RAM 10 functions as a work memory for the CPU 9. The ROM 11 may store data, such as an image correction program used by the CPU 9 to correct the image data. Further, in this example, the ROM 11 stores a plurality of image correction data items, which is previously prepared for a plurality of shooting condition data sets.

The operation device 15 allows a user to input an instruction or set various preferences, for example, through one or more buttons. Through the operation device 15, the user may be able to turn on or off the digital camera 1, turn on or off a flash lamp of the digital camera 1, capture the optical image, change various setting including, for example, the resolution of the image, the zoom position of the lens, the f-number of the lens, etc. Further, the operation device 15 may allow the user to determine whether to apply image correction to the image, or when to apply image correction to the image.

In this example, the image memory 12 is provided separately from the memory card 14. However, the image memory 12 may be incorporated in the memory card 14.

Referring to FIG. 14, operation of correcting image data generated from an optical image captured through a lens, performed by the digital camera 1, is explained according to an example embodiment of the present invention. The operation of FIG. 14 may be performed by the CPU 9 when the user instructs the digital camera 1 to apply image correction when the image is captured. In such case, the CPU 9 loads the image correction program from the ROM 11 onto the RAM 10.

At S11, the CPU 9 instructs the lens system 2, the CCD 3, the CDS 4, and A/D converter 5 to generate image data of an object. At this time, the CPU 9 determines a shooting condition, for example, according to an instruction received from the user through the operation device 15. Alternatively, the CPU 9 may automatically determine the shooting condition. Once the image data is generated, the CPU 9 inputs the image data for further processing. At this time, the image data may be stored in the image memory 12.

At S12, the CPU 9 obtains a captured shooting condition data set, which describes the shooting condition under which the optical image is captured, for further processing.

At S13, the CPU 9 obtains one of the plurality of image correction data items from the ROM 11 that corresponds to the captured shooting condition data set.

At S 14, the CPU 9 corrects the image data using the selected image correction data set to generate processed image data. At this time, various image processing may be applied before or after correcting the image data.

At S15, the CPU 9 compresses the processed image data using the compressor/expander 13.

At S16, the CPU 9 stores the compressed, processed image data in a storage device or medium, such as the image memory 12 or the memory card 14, and the operation ends.

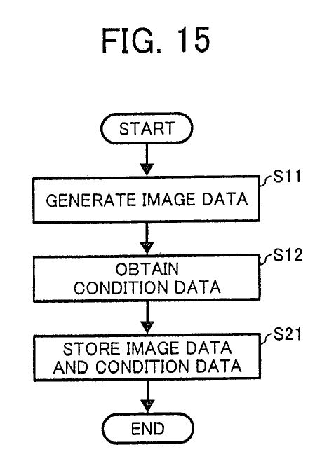

Referring now to FIG. 15, operation of storing image data generated from an optical image captured through a lens together with a captured shooting condition data set, performed by the digital camera 1, is explained according to an example embodiment of the present invention. The operation of FIG. 15 may be performed when the user instructs the digital camera 1 to store the image data without applying image correction at the time of capturing. In such case, the CPU 9 loads the image correction program from the ROM 11 onto the RAM 10.

At S11, the CPU 9 obtains image data of an object in a substantially similar manner as described above referring to S11 of FIG. 14.

At S12, the CPU 9 obtains a captured shooting condition data set, which describes the shooting condition under which the optical image is captured, in a substantially similar manner as described above referring to S12 of FIG. 14.

At S21, the CPU 9 stores the image data and the captured shooting condition data set together in a storage device or medium, such as the image memory 12 or the memory card 14, and the operation ends. For example, the image data may be stored in the Exif format, which has property data including the captured shooting condition data set. Further, in this example, various other kinds of information may be stored as the property data in addition to the zoom position, the object distance, and/or the aperture size, for example, including a manufacturer of the digital camera 1, an identification number assigned to the digital camera 1, or the date and time when the image is captured.

The image data, which may be stored as described above referring to FIG. 15, may be corrected by the digital camera 1 of FIG. 13 at later time. In such case, the CPU 9 reads the image data and the captured shooting condition data set from the storage device or medium, and applies image correction to the image data in a substantially similar manner as described above referring to FIG. 14.

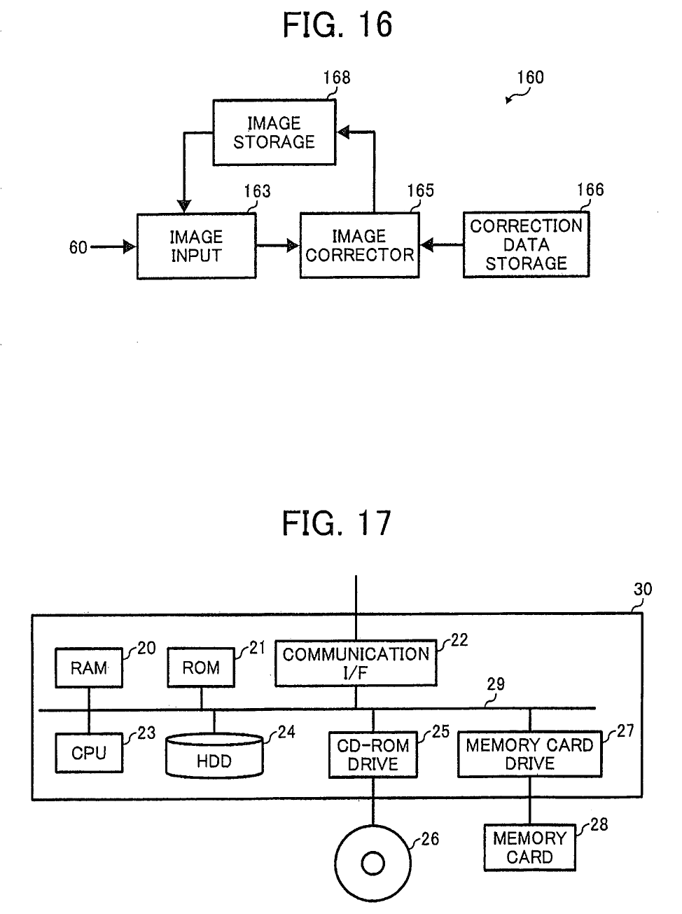

Alternatively, the image data may be corrected by a second image correcting system 160 shown in FIG. 16. Referring to FIG. 16, the second image correcting system 160 includes an image input 163, an image corrector 165, a correction data storage 166, and an image storage 168.

The image input 163 inputs the image data and the captured shooting condition data set, which may be obtained from a storage. The storage may be implemented by any kind of storage device or medium, as long as it stores the image data and the captured shooting condition data set. For example, the storage may correspond to any one of the data storage 67 of FIG. 12, the image storage 68 of FIG. 12, and the image storage 168 of FIG. 16. The correction data storage 166 stores a plurality of image correction data items previously prepared for a plurality of shooting condition data sets. The image corrector 165 obtains the captured shooting condition data set from the image input 163, and selects the image correction data item that corresponds to the captured shooting condition data set from the correction data storage 166. Using the selected image correction data item, the image corrector 165 applies image correction to the image data to generate processed image data. The image storage 168 stores the processed image data.

The image correcting system 160 may be implemented by, for example, an image processing apparatus 30 illustrated in FIG. 17.

Referring to FIG. 17, the image processing apparatus 30 includes a RAM 20, a ROM 21, a communication interface (I/F) 22, a CPU 23, a hard disk drive (HDD) 24, a CD-ROM drive 25, a CD-ROM 26, a memory card drive 27, and a memory card 28, which are coupled to one another via a bus 29.

The CPU 23 controls operation of the image processing apparatus 30. The RAM 20 may function as a work memory for the CPU 23. The ROM 21 may store data, such as BIOS. The HDD 24 may store data, such as an image correction program to be used by the CPU 23 to correct the image data, or a plurality of image correction data items previously prepared. The CD-ROM drive 25 may read out data from the CD-ROM 26. The memory card drive 27 may read out data from the memory card 28. The communication I/F 22 allows the image processing apparatus 30 to communicate with other devices via a communication line such as a public switched telephone network, or a network such as a local area network (LAN) or the Internet.

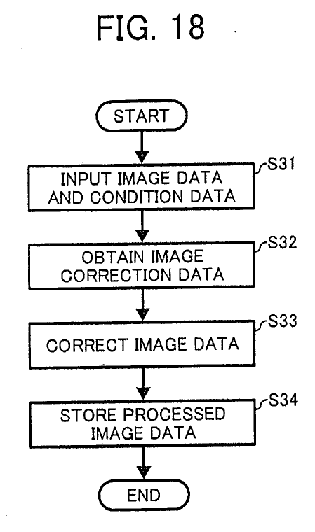

Referring to FIG. 18, operation of correcting image data generated from an optical image captured through a lens, performed by the image processing apparatus 30, is explained according to an example embodiment of the present invention. The operation of FIG. 18 may be performed by the CPU 23 according to the image correction program, after loading the image correction program onto the RAM 20.

In one example, the image correction program may be stored in the CD-ROM 26. The CPU 23 may read out the image correction program from the CD-ROM 26 using the CD-ROM drive 25, and install the image correction program onto the HDD 24. Alternatively, the image correction program may be stored in any other kind of storage medium or device. Examples of storage medium or device include optical discs including CD-R, CD-RW, DVD-ROM, DVD-RAM, DVD-R, DVD+R, DVD-RW, or DVD+RW, magneto optical discs, floppy disks, flexible disks, ROMs, RAMs, EPROMs, EEPROMS, flash memories, memory cards, hard disks, etc. Alternatively, the CPU 23 may download the image correction program from another storage device or medium via the communication I/F 22, and store the image correction program in the HDD 24. Further, the image correction program may operate under any desired operating system to cause the operating system to perform the operation of FIG. 18. Alternatively, the image correction program may be provided as one or more program files, which may be incorporated into an application program or the operating system.

Referring back to FIG. 18, at S31, the CPU 23 inputs image data and a captured shooting condition data set, which may be obtained from any kind of desired device or medium. In one example, the image data and the captured shooting condition data set may be read out from the memory card 28. In such case, the memory card 28 functions as the memory card 14 of FIG. 13, which stores the image data and the captured shooting condition data set stored by the digital camera 1. In another example, the image data and the captured shooting condition data set may be obtained via the communication I/F 22 from the digital camera 1, when the digital camera 1 is connected to the communication I/F 22.

At S32, the CPU 23 selects one of a plurality of image correction data items that corresponds to the captured shooting condition data set. In this example, the plurality of image correction data items is stored in the HDD 24. Alternatively, the plurality of image correction data items may be stored, for example, in a portable medium, such as the CD-ROM 26. In such case, the CPU 23 reads out the selected image correction data item from the CD-ROM 26 using the CD-ROM drive 25. Alternatively, the plurality of image correction data items may be obtained via the communication I/F 22. For example, the image processing apparatus 30 may access a website provided by the manufacturer of the digital camera 1, and download the selected image correction data item from the website.

At S33, the CPU 23 corrects the image data using the selected image correction data item to generate processed image data. In this step, other image processing may be applied.

At S34, the CPU 23 stores the processed image data. At this time, the processed image data may be displayed on a display device, if the display device is connected to the image processing apparatus 30. Alternatively, the processed image data may be printed by a printer, if the printer is available to the image processing apparatus 30. Alternatively, the processed image data may be sent to another device or apparatus through the communication I/F 22.

The operation of FIG. 18 may be performed in various other ways. For example, at S31, the captured shooting condition data set may include identification information, which identifies the imaging apparatus that is used to capture the optical image. Further, a plurality of image correction data items may be stored for a plurality of imaging apparatus types. In such case, at S33, the CPU 23 may select one of the plurality of image correction data items that correspond to the type of the imaging apparatus that is used to capture the optical image. In this manner, the image processing apparatus 30 may be able to correct image data, which may be generated by various types of imaging apparatus.

Numerous additional modifications and variations are possible in light of the above teachings. It is therefore to be understood that within the scope of the appended claims, the disclosure of this patent specification may be practiced in ways other than those specifically described herein.

For example, elements and/or features of different illustrative embodiments may be combined with each other and/or substituted for each other within the scope of this disclosure and appended claims.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

Further, example embodiments of the present invention may include an image correcting system including: means for inputting image data generated from an optical image captured through a lens; means for obtaining a captured shooting condition data set describing a shooting condition under which the optical image is captured; and means for correcting the image data using one of a plurality of image correction data items that corresponds to the captured shooting condition data set. In this example, the plurality of image correction data items may be stored in any desired means for storing.

1. An imaging apparatus, comprising:
a lens system configured to capture an optical image of an object through a lens under a shooting condition;
an image sensor configured to convert the optical image to image data;
a correction data storage configured to store a plurality of distortion correction data items in a corresponding manner with a plurality of shooting condition data sets;
a controller configured to obtain a captured shooting condition data set describing the shooting condition under which the optical image is captured by the lens system, and select one of the plurality of distortion correction data items that corresponds to the captured shooting condition data set, the captured shooting condition data set comprising a zoom position of the lens and a shooting distance between the object and the lens center; and
an image processor configured to correct aberration of the image data using the selected distortion correction data item to generate processed image data.

2. The imaging apparatus of claim 1, wherein each one of the plurality of distortion correction data items is stored in the form of a plurality of polynomial coefficients.

3. The image correcting system of claim 1, wherein the image data is corrected for a selected portion of the image data.

4. The image correcting system of claim 3, wherein the selected portion corresponds to a border section of the image data.

5. An imaging apparatus, comprising:
a lens system configured to capture an optical image of an object through a lens under a shooting condition;
an image sensor configured to convert the optical image to image data;
a correction data storage configured to store a plurality of intensity correction data items in a corresponding manner with a plurality of shooting condition data sets;
a controller configured to obtain a captured shooting condition data set describing the shooting condition under which the optical image is captured by the lens system, and select one of the plurality of intensity correction data items that corresponds to the captured shooting condition data set, the captured shooting condition data set comprising a zoom position of the lens, a shooting distance between the object and the lens center, and an aperture size of the lens; and
an image processor configured to correct intensity reduction of the image data using the selected intensity correction data to generate processed image data.

6. An imaging correcting system, comprising:
an imaging apparatus configured to generate image data of an object, the imaging apparatus comprising:
a lens system configured to capture an optical image of the object through a lens under a shooting condition;
an image sensor configured to convert the optical image to the image data; and
a controller configured to obtain a captured shooting condition data set describing the shooting condition under which the optical image is captured by the lens system, and store the captured shooting condition data set as property data of the image data together with the image data in a storage, the captured shooting condition data set comprising a zoom position of the lens, a shooting distance between the object and the lens center, and an aperture size of the lens.

7. The image correcting system of claim 6, further comprising:
an image processing apparatus configured to couple to at least one of the imaging apparatus and a storage, the image processing apparatus comprising:
a processor; and
a storage device configured to store a plurality of instructions which causes the processor to perform, when executed by the processor, a plurality of functions comprising:
inputting the image data and the captured shooting condition data set obtained from at least one of the imaging apparatus and the storage;
selecting an image correction data item that corresponds to the captured shooting condition data set, the image correction data item comprising a plurality of coefficients indicating expected image data that is expected to be captured by the lens system under the shooting condition; and
correcting the image data using the selected image correction data item to generate processed image data.

8. An image correcting method, comprising:
inputting image data of an object generated from an optical image of the object captured through a lens;
inputting a captured shooting condition data set describing a shooting condition under which the optical image is captured, the captured shooting condition data set comprising a zoom position of the lens, an object distance between the object and the lens center, and an aperture size of the lens;
selecting an image correction data item that corresponds to the captured shooting condition set from a plurality of image correction data items; and
correcting the image data using the selected image correction data item to generate processed image data.

9. The method of claim 8, further comprising:
preparing the plurality of image correction data items in a corresponding manner with a plurality of shooting condition data sets.

10. The method of claim 9, wherein the correcting comprises:
computing an amount of image correction for a selected portion of the image data.

11. The method of claim 9, further comprising:
classifying a plurality of pixels in the image data into a luma component and a chroma component; and
reducing a number of pixels in the chroma component,
wherein the classifying and the reducing are performed before the correcting.

12. A computer program product storing a computer program, adapted to, when executed on a computer, cause the computer to carry out the method of claim 8.
